(19) United States
(12) Patent Application Publication
(10) Pub. No.: US 2026/0232072 A1
(43) Pub. Date: Aug. 13, 2026

(54) LIQUID TPU TEXTURING DURING AND AFTER CURING

(71) Applicant: adidas AG, Herzogenaurach (DE)

(72) Inventor: Henry HANSON, Herzogenaurach (DE)

(21) Appl. No.: 19/538,571

(22) Filed: Feb. 12, 2026

(30) Foreign Application Priority Data
Feb. 13, 2025 (DE) 10 2025 105 382.0
Feb. 11, 2026 (EP) 26157742.3

(51) Int. Cl. A43B 13/04; A43B 13/12; A43B 13/14

(52) U.S. Cl. CPC A43B 13/04; A43B 13/12; A43B 13/14

(57) ABSTRACT

A method for manufacturing a sole structure, including: providing a liquified polymer; arranging the liquified polymer onto a base layer; curing the liquified polymer; disposing the cured polymer in a mold structure comprising a textured sole imprint; heating the mold structure and pressing the cured polymer against the textured sole imprint; heating the cured polymer to at least partially melt the cured polymer; and molding the textured sole imprint on an outer surface of the at least partially melted cured polymer, thereby obtaining the sole structure.

### CROSS-REFERENCE TO RELATED APPLICATIONS

This application claims priority to European Patent Application No. 26157742.3, filed Feb. 11, 2026, and German Patent Application No. 102025105382.0, filed February 13, 2025, each of which is incorporated by reference herein in its entirety.

### TECHNICAL FIELD

Some embodiments of the present disclosure are directed to a method for manufacturing a sole structure, such as a sole structure for a shoe (e.g., a sports shoe). Some embodiments of the present disclosure are directed to a method of manufacturing a sole structure and an outsole for a shoe (e.g., a sports shoe). Some embodiments of the present disclosure are directed to a method of manufacturing a shoe (e.g., a sports shoe).

### BACKGROUND

Different types of sport may benefit from different types of sole structures to promote stability. For example, sole structures on outsoles in shoes (e.g., sports shoes), such as lugs, cleats, or patterned treads, may provide various performance advantages depending on the sport. These structures may, e.g., enhance traction, grip, design, stability and the athlete’s perception, reducing the risk of slipping and improving movement efficiency, for example.

The manufacture of sole structures on outsoles in shoes (e.g., sports shoes) may involve injection molding, which may be used for shoes (e.g., sports shoes) that may benefit from lightweight and flexible outsoles. In this process, thermoplastic materials such as EVA (ethylene vinyl acetate), TPU (thermoplastic polyurethane), or rubber compounds may be melted and injected under high pressure into a steel mold that defines the sole’s shape and tread pattern. One drawback of this process is the generally cost-expensive production of molds. For example, molds may be made of steel and may require precision engineering, which may make them expensive to produce, especially for, e.g., small production runs or frequent design changes. Additionally, injection molding may be limited in material options, as not all rubber compounds are suitable for this process.

A different approach may comprise the addition of engravings to the final sole, e.g., using laser engraving. For example, after the outsole is manufactured, a laser engraving machine may burn the desired structure into the surface. A disadvantage of this method is that the addition of the texture takes place after the sole has been crafted, leading to an inflexible process step.

Other techniques such as embossing and debossing, surface roughening, cutting and grooving may also be performed after the outsole has been manufactured. Accordingly, these techniques may be used as one of the last steps in the manufacture of sole structures.

However, a disadvantage of these soles is that they may be heavy and thick, both impacting on the athlete’s performance and thus making them undesirable. A further disadvantage is that the process of producing the sole structure generally cannot be flexibly changed or implemented during the overall manufacture process and its application is rather rigid. Furthermore, another disadvantage is the inflexible design of the structure, which, once prepared, generally cannot be easily changed or adapted to specific needs of the sole or athlete.

### BRIEF SUMMARY

Therefore, the object of the present disclosure is to provide an improved method, sole structure and outsole, as well as a sports shoe comprising the sole structure in order to at least partly overcome the above-mentioned deficiencies of the prior art.

The above-outlined problems are addressed by some embodiments of the present disclosure.

A first embodiment (1) of the present disclosure is directed to a method for manufacturing a sole structure, such as a sole structure for a sports shoe, comprising the steps of: (a) providing a liquified polymer and/or a polymer layer or parts thereof; (b) providing a liquified polymer and/or a polymer layer or parts thereof; and curing the liquified polymer; wherein the method comprises a first group of steps and/or a second group of steps, wherein the first group of steps comprises: (d) partially curing the liquified polymer obtained in step (b); and texturing the partially cured polymer before step (c); wherein the second group of steps comprises: (f) disposing the cured polymer obtained in step (c) and/or the polymer layer or parts thereof obtained in step (b) in a mold structure comprising a textured sole imprint; (g) heating the mold structure, by, e.g., applying steam into the mold structure, while pressing the cured polymer and/or the polymer layer or parts thereof against the textured sole imprint; (h) heating the cured polymer and/or the polymer layer or parts thereof in order to melt at least partially the cured polymer and/or the polymer layer or parts thereof, and to substantially mold the textured sole imprint on the outer surface of the cured polymer and/or the polymer layer or parts thereof; (i) thereby obtaining the sole structure.

In a second embodiment (2), the polymer layer or parts thereof according to the first embodiment (1) is arranged on a carrier layer.

In a third embodiment (3), the polymer layer or parts thereof according to any one of embodiments (1)–(2) comprise(s) one or more cutout(s).

In a fourth embodiment (4), in the step of texturing the partially cured polymer according to any one of embodiments (1)–(3), a texturing element is applied on the partially cured polymer, wherein the texturing element is air-permeable.

In a fifth embodiment (5), the texturing element according to the fourth embodiment (4) is applied onto the partially cured polymer for at least 5 minutes, at least 1 hour, at least 6 hours, at least 12 hours, or at least 24 hours.

In a sixth embodiment (6), the texturing element according to any one of embodiments (1)–(5) is a textile.

In a seventh embodiment (7), the curing time in the step of partially curing the liquified polymer according to any one of embodiments (1)–(6) ranges from 10 minutes to 60 minutes, from 15 minutes to 40 minutes, or from 20 minutes to 35 minutes, or is 30 minutes.

In an eighth embodiment (8), the sole structure according to any one of embodiments (1)–(8) comprises a surface structure.

In a ninth embodiment (9), the surface structure according to the eighth embodiment (8) is selected from the group comprising one or more of: rectangular, grid, lattice, line, spiral, honeycomb, dots, wave or any combination thereof.

In a tenth embodiment (10), the sole structure according to any one of embodiments (1)–(10) is an outsole of the shoe (e.g., the sports shoe).

In an eleventh embodiment (11), the liquified polymer and/or the polymer layer or parts thereof according to any one of embodiments (1)–(10) is arranged onto one or more sections of the shoe (e.g., the sports shoe), including a toe section, a forefoot section, a heel section, a midsole section, a sidewall section and/or an upper section.

In a twelfth embodiment (12), the liquified polymer and/or the polymer layer or parts thereof according to any one of embodiments (1)–(11) is arranged onto one or more predetermined portions of the shoe (e.g., the sports shoe) determined using a traction map, an abrasion map and/or a pressure map.

In a thirteenth embodiment (13), the liquified polymer and/or the polymer layer or parts thereof according to any one of embodiments (1)–(12) is arranged onto the base layer with a thickness ranging from 1 mm to 10 mm, or from 2 mm to 4 mm, or is 3 mm.

In a fourteenth embodiment (14), the thickness of the sole structure according to any one of embodiments (1)–(13) ranges from 0.3 mm to 0.7 mm, or is 0.5 mm.

In a fifteenth embodiment (15), the arranging step according to any one of embodiments (1)–(14) is carried out by at least one of the following techniques: brushing, coating, dipping, painting, automated dispensing, automated printing, controlled dispensing.

In a sixteenth embodiment (16), the base layer according to any one of embodiments (1)–(15) is a mid-sole and/or a shoe upper and/or parts thereof.

In a seventeenth embodiment (17), the liquified polymer according to any one of embodiments (1)-(16) is arranged in a first section of the shoe (e.g., the sports shoe) with a dynamic viscosity of ranging from 30000 mPa-s to 50000 mPa-s; and in a second section of the shoe (e.g., the sports shoe) with a dynamic viscosity ranging from 10000 mPa∙s to 30000 mPa∙s.

In an eighteenth embodiment (18), the contact angle between the liquified polymer and the base layer according to any one of embodiments (1)–(17) ranges from 30° to 110°, from 40° to 90°, or from 50° to 70°.

In a nineteenth embodiment (19), the curing steps according to any one of embodiments (1)–(18) are carried out using radiation.

In a twentieth embodiment (20), the liquified polymer according to any one of embodiments (1)–(19) comprises a polymer and a solvent; wherein the polymer is selected from the group of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

In a twenty-first embodiment (21), the solvent according to the twentieth embodiment (20) is a mixture selected from the group of solvent-borne and/or water-borne solvents, and/or selected from the group of (C1-C6) ethers, (C1-C10) esters, (C1-C8) ketones, (C1-C8) alkanes, and/or combinations thereof.

In a twenty-second embodiment (22), the solvent according to any one of embodiments (20)–(21) is a mixture of one or more of tetrahydrofuran (THF), methyl ethyl ketone (MEK), cyclohexane (CYC), ethyl acetate, and butyl acetate.

In a twenty-third embodiment (23), the ratio of the mixture according to any one of embodiments (20)–(22) ranges from 10 vol. % to 90 vol. %., from 20 vol.% to 80 vol. %, or from 30 vol. % to 70 vol. %.

In a twenty-fourth embodiment (24), the polymer according to the twentieth embodiment (20) is characterized by a Shore A value and/or Shore D value, wherein the Shore A value ranges from 20 to 120, from 40 to 100, or from 60 to 80; and the Shore D value ranges from 2 to 80, from 5 to 75, or from 8 to 70.

In a twenty-fifth embodiment (25), the ratio of the polymer to the solvent according to any one of embodiments (20)–(24) ranges from 2:98 vol.% to 40:60 vol.%, from 5:95 vol.% to 30:70 vol.%, or from 10:90 vol.% to 20:80 vol.%.

In a twenty-sixth embodiment (26), the liquified polymer according to any one of embodiments (1)-(25) comprises a dynamic viscosity ranging from 10000 mPa∙s to 50000 mPa-s, or from 20000 mPa∙s to 40000 mPa∙s.

In a twenty-seventh embodiment (27), in the curing step according to any one of embodiments (1)–(26) a curing temperature ranging from 20°C to 150°C, from 30°C to 100°C, or from 40°C to 50°C is used; and wherein in the step of curing the liquified polymer the curing time ranges from 2 minutes to 750 minutes, from 5 minutes to 390 minutes, or from 10 minutes to 180 minutes.

A twenty-eighth embodiment (28) of the present disclosure is directed to a sole structure manufactured according to the method of any one of embodiments (1)–(27).

A twenty-ninth embodiment (29) of the present disclosure is directed to an outsole manufactured according to the method of any one of embodiments (1)–(27).

In a thirtieth embodiment (30), the outsole according to the twenty-ninth embodiment (29) has a surface structure.

A thirty-first embodiment (31) of the present disclosure is directed to a shoe (e.g., a sports shoe) comprising a sole structure according to the twenty-eighth embodiment (28) or an outsole according to any one of embodiments (29)–(30).

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows a flow diagram of a method for manufacturing a sole structure, according to some embodiments.

FIG. 2 shows a sole structure manufactured according to some embodiments of the method described herein.

FIG. 3 shows a sole structure manufactured according to some embodiments of the method described herein.

FIG. 4 shows a sole structure manufactured according to some embodiments of the method described herein.

FIG. 5 shows an embodiment of an outsole comprising a sole structure, according to some embodiments.

FIG. 6 shows a manufacturing process for the outsole shown in FIG. 5 comprising the sole structure, according to some embodiments of the present disclosure.

### DETAILED DESCRIPTION

Embodiments of the present disclosure are described below, predominately with respect to shoes, such as sport shoes. It is, however, once again emphasized that the different embodiments may also be practiced in different kinds of soles and shoes and are not limited to the specific embodiments set forth below.

Reference is further made to the fact that a skilled artisan will understand that the features and possible modifications described with reference to the specific embodiments discussed herein may also be further modified and/or combined with another embodiment in a different manner or in different sub-combinations, without departing from the scope of the present disclosure. Individual features or sub-features may also be omitted, where compatible.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

Some embodiments of the presented disclosure are directed to a method for manufacturing a sole structure, such as a sole structure for a shoe (e.g., a sports shoe), comprising the steps of:
a. providing a liquified polymer and/or a polymer layer or parts thereof;
b. arranging the liquified polymer and/or a polymer layer or parts thereof onto a base layer; and
c. curing the liquified polymer;
wherein the method comprises a first group of steps and/or a second group of steps, wherein the first group of steps comprises:
d. partially curing the liquified polymer obtained in step b; and
e. texturing the partially cured polymer before step c;
wherein the second group of steps comprises:
f. disposing the cured polymer obtained in step c and/or the polymer layer or parts thereof obtained in step b in a mold structure comprising a textured sole imprint;
g. heating the mold structure, preferably by applying steam into the mold structure, while pressing the cured polymer and/or the polymer layer or parts thereof against the textured sole imprint;
h. heating the cured polymer and/or the polymer layer or parts thereof in order to melt at least partially the cured polymer and/or the polymer layer or parts thereof, and to substantially mold the textured sole imprint on the outer surface of the cured polymer and/or the polymer layer or parts thereof;
i. thereby obtaining the sole structure.

Some embodiments of the present disclosure may provide a more flexible process for producing sole structures. A conventional sole structure, for example a structured outsole for a shoe (e.g., a sports shoe) may be manufactured by, e.g., injection molding. Some embodiments of the present disclosure may be manufactured based on a different approach, for example, the provision of a liquified and/or of a polymer layer or parts thereof which may be arranged on the base layer. Some embodiments of the method according to the present disclosure are more efficient compared to conventional solutions, as they may integrate the step of texturing into the production process. Furthermore, texturing during post curing may offer flexibility for customization of the sole structure and the overall process. This dual capability may be valuable for improving the sole structure and its method for manufacturing.

Some embodiments of the method for manufacturing a sole structure according to the present disclosure reduce or eliminate the need for additional surface treatments, which may reduce cycle time and increase throughput. Furthermore, in some embodiments, the combination of curing and texturing in a single step may avoid the cost of post-processing equipment, like lasers or chemical etching systems, and may reduce labor costs. Moreover, in some embodiments, texturing during curing and post-curing may result in fewer processing steps, which may lead to lower energy consumption for heating, handling, or operating additional machinery. Some embodiments of the method according to the present disclosure may further allow for individual changes or customization during the process, like unique branding, part identification, or product differentiation without the necessity to alter the process or mold. In this manner, in some embodiments, process cost and time of creating new molds or dies when a different texture is required may be avoided, leading to a more cost-efficient manufacturing process.

Furthermore, in some embodiments of the method according to the present disclsoure, a more scalable process is provided. When increasing the production volume, some embodiments of the method according to the present disclosure remain efficient as, for example, texturing during curing may be incorporated as an automated process, which may lead to high repeatability and high throughput.

Moreover, in some embodiments of the method according to the present disclosure, e.g., glue- and injection molding-based deposition may be avoided while providing a sole structure with enhanced traction and friction performance.

Accordingly, some embodiments of the method according to the present disclosure may improve speed, cost, flexibility in automation (e.g., an automated, scalable approach), material efficiency, risk management (in addition to or as an alternative for process flexibility) and customization of the overall process for manufacturing a sole structure.

While some embodiments of the sole structure may be used to create a lighter and thinner, e.g., outsole, the sole structure may be further used to enhance the grip of the shoe (e.g., the sports shoe) for particular workouts, e.g., when arranging the liquified polymer and/or the polymer layer or parts thereof in particular zones of the shoe (e.g., the sports shoe).

In this manner, in some embodiments, the sole structure may be manufactured more efficiently while the liquified polymer may be arranged more precisely and effectively. By doing so, in some embodiments, no material waste is produced, e.g., by cutting excess material. In this manner, some embodiments of the method according to present disclosure may provide an improved method for producing a sole structure for, e.g., a sports shoe, by minimizing material consumption and avoiding any waste production.

Some embodiments of the method according to the present disclosure have shown to provide a sole structure that may enhance traction on smooth and wet surfaces while reducing the probability of slipping. When using some embodiments of the sole structure according to the present disclosure, the running performance of the wearer, e.g., an athlete, may be improved. Due to the reduced risk of slipping, e.g., on wet and smooth surfaces, the sole structure may provide for an improved workout experience and result. For example, when comparing to conventional sole structures, embodiment of the sole structure according to the present disclosure may exhibit an improvement in friction. Moreover, in some embodiments, the sole structure may have the advantage that it can be individually designed based on the friction force that acts on the sole structure. Furthermore, in some embodiments, the sole structure may be lighter and thinner, due to the materials and the manufacturing method as described herein, making the overall sole structure more desirable. In some embodiments, the sole structure may further be individually designed based on the force magnitude and/or force direction at different parts of, e.g., the shoe. In this manner, in some embodiments, the sole structure may be improved for different sports and different athletes.

As used herein, a “sole structure” is, but not limited to, any part of a shoe or footwear that provides structure, texture, and/or traction for the wearer. The method according to the present disclosure, in some embodiments, may be used for manufacturing, e.g., the sidewall of a midsole. For example, in some embodiments, sole structure may comprise, e.g., an outsole which overlaps onto the midsole. In other words, in some embodiments, the sole structure may be an outsole that wraps onto a midsole. In some embodiments, sole structure may further comprise any part of a midsole and/or overlapping parts of the outsole onto the midsole, e.g., a separate sidewall layer of a midsole. In some embodiments, a sidewall layer may be based on, e.g., liquid TPU. In this manner, in some embodiments, this sidewall layer may be advantageous for protecting, e.g., lightweight foams used in, for example, trail and/or outdoor shoes.

As used herein, a “polymer” is, but not limited to, a polymer material. In some embodiments, the polymer may be made from durable and long-lasting materials. For example, the polymer may provide for the contacting zone, which may be in contact with the ground during, e.g., the course of a gait. Furthermore, in some embodiments, the polymer may provide flexibility, durability, cushioning, and support in the sole structure.

As used herein, a “polymer layer or parts thereof” may comprise any polymer film or parts thereof. For example, in some embodiments, a polymer layer may be a thin layer of polymer. In some embodiments, the polymer layer may have cutouts. In this regard, the parts of the polymer layer may comprise the cutouts of the polymer layer. In some embodiments, these cutouts from the polymer layer may be referred to as “parts thereof”.

As used herein, a “ base layer” is, but not limited to, a foundational part of the sole structure and may help to maintain the structural integrity of the sole structure. In some embodiments, the base layer may be a midsole and/or a shoe upper and/or parts thereof. In some embodiments, the base layer may be removed from the shoe (e.g., the sports shoe) when further processing the sole structure and, therefore, the base layer does not necessarily need to be integral with the shoe (e.g., the sports shoe). In some embodiments, the base layer may be, e.g., a midsole and may include materials that absorb shock and reduce the impact on the joints. In some embodiments, the base layer may be made from durable materials to withstand the wear and tear of regular use. In some embodiments, the base layer may work in conjunction with other layers of the sole structure and the sports shoe.

As used herein, the “liquified polymer” is to be understood, but not limited to, as the polymer having semi-solid or liquid physical properties. In some embodiments, the liquified polymer comprises a polymer and a liquifying element, such as a solvent.

As used herein, “curing” is to be understood, but not limited to, as a chemical and/or physical process of hardening, setting, and/or solidification of the polymer. In some embodiments, curing may be carried out using radiation.

As used herein, “mixing” is to be understood, but not limited to, as a process of combining two or more substances resulting in a mixture of the individual substances. In some embodiments, the mixture is a liquid.

As used herein, “arranging” is to be understood, but not limited to, as a process of applying and/or depositing, for example, the liquified polymer onto the base layer.

For example, in some embodiments, the liquid material may be applied to a base layer, which may be a carrier layer. In some embodiments, the carrier layer may then be attached to, e.g., the midsole. In some embodiments, the liquified polymer may be applied directly to the midsole. In this regard, in some embodiments, partially curing the liquified polymer and texturing the partially cured polymer may be performed.

In some embodiments, the liquified polymer may be applied to a base layer (such as a carrier layer). In this regard, in some embodiments, disposing the cured polymer obtained in step c (as discussed herein) and/or the polymer layer or parts thereof obtained in step b (as discussed herein) in a mold structure comprising a textured sole imprint and/or heating the mold structure, e.g., by applying steam into the mold structure, while pressing the cured polymer and/or the polymer layer or parts thereof against the textured sole imprint; heating the cured polymer and/or the polymer layer or parts thereof in order to melt at least partially the cured polymer and/or the polymer layer or parts thereof, and to substantially mold the textured sole imprint on the outer surface of the cured polymer and/or the polymer layer or parts thereof, and/or thereby obtaining the sole structure is performed.

In some embodiments, any or all of steps f) to h) may be performed with a liquified polymer:

f. disposing (160) the cured polymer (232) obtained in step c and/or the polymer layer or parts thereof obtained in step b in a mold structure (300) comprising a textured sole imprint (340);

g. heating (170) the mold structure (300), preferably by applying steam into the mold structure (300), while pressing the cured polymer (232) and/or the polymer layer or parts thereof against the textured sole imprint (340);

h. heating (180) the cured polymer (232) and/or the polymer layer or parts thereof in order to melt at least partially the cured polymer and/or the polymer layer or parts thereof, and to substantially mold the textured sole imprint (340) on the outer surface of the cured polymer (232) and/or the polymer layer or parts thereof;

In addition, or alternatively, any or all of steps f) to h) may be performed using a polymer layer, such as a polymer layer based on TPU:

f. disposing (160) the cured polymer (232) obtained in step c and/or the polymer layer or parts thereof obtained in step b in a mold structure (300) comprising a textured sole imprint (340);

g. heating (170) the mold structure (300), preferably by applying steam into the mold structure (300), while pressing the cured polymer (232) and/or the polymer layer or parts thereof against the textured sole imprint (340);

h. heating (180) the cured polymer (232) and/or the polymer layer or parts thereof in order to melt at least partially the cured polymer and/or the polymer layer or parts thereof, and to substantially mold the textured sole imprint (340) on the outer surface of the cured polymer (232) and/or the polymer layer or parts thereof;

In some embodiments, the polymer layer may be polymer film, e.g., a TPU film. In some embodiments, the polymer layer may be inserted into the mold structure.

In some embodiments, the polymer layer or parts thereof may be arranged on a carrier layer. A carrier layer may comprise, in some embodiments, any structural and/or supporting layer. In some embodiments, the carrier layer is arranged, for example, in a multi-layered material system. The carrier layer may provide stability and facilitate processing. For example, in some embodiments, the carrier layer may act as a substrate for additional processing steps, such as coatings, adhesives, or functional layers. In some embodiments, a carrier layer may comprise a material selected from the group comprising: thermoplastic polyurethane (TPU), rubber, polyester, aramid fibers, carbon fibers, glass fibers, and ultra-high molecular weight polyethylene (e.g. Dyneema) and/or ethylene vinyl acetate (EVA).

In some embodiments, the polymer layer or parts thereof may comprise one or more cutout(s). In some embodiments, cutouts of the polymer layer may be, for example, designed openings, perforations, and/or recesses. In some embodiments, the polymer layer comprises one or more cutout(s) in a pattern. Accordingly, in some embodiments, the openings, perforations and/or recesses, e.g., parts of the polymer layer, may comprise a pattern. By using the one or more cutouts, in some embodiments, the flexibility, traction, and cushioning characteristics of the sole structure may be enhanced. Moreover, the one or more cutouts may provide for weight reduction of the sole structure.

In some embodiments, in the step of texturing the partially cured polymer, a texturing element may be applied on the partially cured polymer. In some embodiments, the texturing element may be air-permeable.

In some embodiments, the use of an air-permeable texturing element may promote the applied force being uniformly distributed across the entire surface, and prevent pressure differentials caused by trapped air. In this manner, this may lead to a more even and uniform surface structure across the entire sole structure surface. Furthermore, in some embodiments, an air-permeable texturing element may maintain constant pressure, promoting the texture being “locked in” as the material cures, e.g., hardens. In this manner, in some embodiments, defects such as deformation, misalignment, or loss of texture precision may be minimized. Another advantage of using an air-permeable texturing element is that, in this manner, solvent may be allowed to leave the polymer through evaporation. This is helpful because the surface of the partially cured polymer may not fully cure if the texturing element is not air-permeable (in some instances). In other words, drying and/or curing may take a considerably longer time. In some embodiments, the texturing element may be a mold, stamp, embossing tools and/or textile.

In some embodiments, the texturing element may be applied onto the partially cured polymer for at least 5 minutes. In some embodiments, the texturing element may be applied onto the partially cured polymer for at least 1 hour. In some embodiments, the texturing element may be applied onto the partially cured polymer for at least 6 hours. In some embodiments, the texturing element may be applied onto the partially cured polymer for at least 12 hours. In some embodiments, the texturing element may be applied onto the partially cured polymer for at least 24 hours.

In this manner, in some embodiments, the partially cured polymer is allowed to cure during the application of the texturing element. This one-step process may provide for a time- and energy-efficient process of texturing.

In some embodiments, the texturing element may be a textile. Textiles may exhibit complex, irregular patterns such as fibers, weaves, and meshes that are difficult to replicate with conventional molds. By using a textile, in some embodiments of the method according to the present disclosure, a more "natural" and biomimetic surface structure may obtained in the sole structure. These textures may be, for example, beneficial for sole structures with a soft, organic, or natural design.

In some embodiments, the curing time in the step of partially curing the liquified polymer may range from 10 minutes to 60 minutes. In some embodiments, the curing time in the step of partially curing the liquified polymer may range from 15 minutes. to 40 minutes. In some embodiments, the curing time in the step of partially curing the liquified polymer may range from 20 minutes. to 35 minutes. In some embodiments, the curing time in the step of partially curing the liquified polymer may be 30 minutes.

In some embodiments, the sole structure may comprise a surface structure. In this manner, in some embodiments, the sole structure may provide traction and grip when used by a wearer. Furthermore, the surface structure may allow for a rough design, which may be desirable for the user.

In some embodiments, the surface structure may be selected from the group consisting of one or more of: a rectangle, a grid, a lattice, a line, a spiral, a honeycomb, dots, a wave, or any combination thereof. In some embodiments, the sole structure may be individually designed and may provide a plurality of surface structures. In some embodiments, the sole structure may have more than one surface structure. Alternatively, or in addition, in some embodiments, the surface structure may be an outlined and/or filled pattern.

These surface structure configurations may improve the traction of the sole structure, which may help the wearer to maintain a secure footing on a variety of surfaces. For example, due to this improved traction, the wearer may experience greater stability, which may reduce the chances of slipping or losing balance. This may be helpful in sports requiring, e.g., sudden stops, lateral movements, and quick turns, such as, e.g., running, football, basketball, and tennis. For example, using the patterns according to the present disclosure may allow for faster turns, cuts, and lateral movements.

In some embodiments, the sole structure may be an outsole of the shoe (e.g., the sports shoe). In this manner, the outsole may provide improved traction and grip as well as provide a design, such as individual surface structure. For example, in some embodiments, the sole structure may be used to provide for a badge branding. In other words, in some embodiments, the sole structure may have the advantage of providing for an outsole that may be used for, e.g., design purposes.

In some embodiments, the liquified polymer may be arranged onto one or more sections of the shoe (e.g., the sports shoe), including a toe section, a forefoot section, a heel section, a midsole section, a sidewall section and/or an upper section. In some embodiments, the liquified polymer may be applied onto different sections while being individually textured in the subsequent steps. Moreover, in some embodiments, the liquified polymer may be arranged onto a plurality of sections.

In some embodiments, the liquified polymer may be arranged onto one or more predetermined portions of the shoe (e.g., the sports shoe) determined using a traction map. In some embodiments, the liquified polymer may be arranged onto one or more predetermined portions of the shoe (e.g., the sports shoe) determined using an abrasion map. In some embodiments, the liquified polymer may be arranged onto one or more predetermined portions of the shoe (e.g., the sports shoe) determined using a pressure map. These configurations may allow the sole structure to be individually adapted to specific needs of the user.

In some embodiments, the liquified polymer may be arranged onto the base layer with a thickness ranging from 1 mm to 10 mm. In some embodiments, the liquified polymer may be arranged onto the base layer with a thickness ranging from 2 mm to 4 mm. In some embodiments, the liquified polymer may be arranged onto the base layer with a thickness of 3 mm.

In some embodiments, the thickness of the sole structure may range from 0.3 mm to 0.7 mm. In some embodiments, the thickness of the sole structure may be 0.5 mm.

In some embodiments, the arranging step may be carried out by at least one of the following techniques: brushing, coating, dipping, painting, automated dispensing, automated printing, controlled dispensing. In some embodiments, the arranging step may be carried out by screen printing.

In some embodiments, the liquified polymer may be arranged onto the base layer by 3D printing. In some embodiments, 3D printing may comprise additive manufacturing techniques, such as stereolithographic methods and laser sintering. With stereolithographic techniques, light may cause chemical monomers and oligomers to cross-link together to form layer-wise polymers making up the 3D printed object. With laser sintering, a laser may cause powdered material to sinter due to heat. Aiming the laser at points in space defined by a 3D model, binding the material together creates a solid structure. Another example of an additive manufacturing method is fused deposition modeling, in which the part may be produced by extruding small beads or streams of material which harden immediately to form layers. If both the midsole and the upper are manufactured using a 3D printing process, the midsole and the upper may be manufactured in separate 3D printing processes and connected afterwards, e.g., by gluing, welding sewing, etc. Additionally or alternatively, the midsole and the upper may be manufactured together in a single manufacturing step.

In some embodiments, the base layer may be a midsole. In some embodiments, the base layer may be a shoe upper. In some embodiments, the base layer may be a portion of a midsole and/or an upper. Accordingly, in some embodiments, the liquified polymer may be arranged onto, e.g., the midsole, thus forming an outsole. In such configurations (as well as others), the polymer material may be an Ethylene-vinyl acetate (EVA), a thermoplastic urethane (TPU) or a supercritical foam. These materials may provide good cushioning properties while being relatively lightweight.

In some embodiments, the liquified polymer may be arranged in a first section of the sports shoe with a dynamic viscosity ranging from 30000 mPa∙s to 50000 mPa∙s; and in a second section of the sports shoe with a dynamic viscosity ranging from 10000 mPa∙s to 30000 mPa∙s.

Different viscosities may be obtained by varying the mixing ratio of the solvent and the polymer. In this manner, in some embodiments, it is possible to deposit different viscous materials on the second component by using one operation step. Such configuration may promote flexible adaptation of the operation step based on the needs of the product.

In some embodiments, the contact angle θ between the liquified polymer and the base layer may range from 30° to 110°. In some embodiments, the contact angle θ between the liquified polymer and the base layer may range from 40° to 90°. In some embodiments, the contact angle θ between the liquified polymer and the base layer may range from 50° to 70°.

In some embodiments, the curing step(s) may be carried out using radiation. In this way, in some embodiments, the liquified component which is deposited on the second component may be cured on the second component while at the same time removing the solvent and drying the deposited liquified component.

In some embodiments, the liquified polymer may comprise a polymer and a solvent. The polymer may be selected from the group of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

In some embodiments, the use of these polymers may allow for a time efficient and sustainable process in the production of the component. Suitable polymer materials may be elastic foam materials, such as thermoplastic elastomers and/or elastomers. In some embodiments, the polymers may be urethane-based thermoplastic elastomers (TPU), polyester-based thermoplastic elastomers (TPE) and/or polyamide-based thermoplastic elastomers (TPA).

In some embodiments, these polymers may allow for enhanced traction while reducing the probability of slipping. Moreover, the use of these specific polymers has shown that a time efficient and sustainable process in the production of the sole structure may be achieved while providing for a more durable and long-lasting sole structure. Suitable polymer materials may be elastic foam materials, such as thermoplastic elastomers and/or elastomers.

In some embodiments, the solvent may be a mixture selected from the group of solvent-borne and/or water-borne solvents. In some embodiments, the solvent may be a mixture selected from the group consisting of (C₁-C₆) ethers, (C₁-C₁₀) esters, (C₁-C₈) ketones, (C₁-C₈) alkanes, and/or combinations thereof.

These solvents have shown compatibility with the production method of the component, while allowing for flexible adaptation of physical characteristics of the polymer to the requirements of the product and the process.

In some embodiments, the solvent may be a mixture of one or more of tetrahydrofuran (THF), methyl ethyl ketone (MEK), cyclohexane (CYC), ethyl acetate, butyl acetate.

These solvents have the advantage that they may be removed in a time efficient manner during the curing process and may allow for a production process that is capable of adapting to various physical properties of the liquid polymer.

In some embodiments, the ratio of the mixture may range from 10 volume % to 90 volume % relative to the total volume of the mixture. In some embodiments, the ratio of the mixture may range from 20 volume % to 80 volume % relative to the total volume of the mixture. In some embodiments, the ratio of the mixture may range from 30 volume % to 70 volume % relative to the total volume of the mixture.

In this manner, these ratios of the mixture of the solvent may have compatibility for both mixing the polymer and changing/adapting the physical characteristics of the liquified polymer to the requirements of the product and the process.

In some embodiments, the polymer may be characterized by a Shore A value. In some embodiments, the polymer may be characterized by a Shore D value. The Shore A value may range from 20 to 120. In some embodiments, the Shore A value may range from 40 to 100. In some embodiments, the Shore A value may range from 60 to 80. The Shore D value may range from 2 to 80. In some embodiments, the Shore D value may range from 5 to 75. In some embodiments, the Shore D value may range from 8 to 70.

The use of a polymer comprising these Shore A and/or Shore D values may provide for the durable properties of the polymer layer and the overall sole structure.

In some embodiments, the ratio of the volume of the polymer to the volume of the solvent may range from 2:98 to 40:60. In some embodiments, the ratio of the volume of the polymer to the volume of the solvent may range from 5:95 to 30:70. In some embodiments, the ratio of the volume of the polymer to the volume of the solvent may range from 10:90 to 20:80.

These ratios of the volume of the solvent to the volume of the polymer may allow for convenient use in the deposition process and flexible adaptation to the requirements of the product and/or process.

In some embodiments, the liquified polymer may comprise a dynamic viscosity ranging from 10000 mPa∙s to 50000 mPa∙s. In some embodiments, the liquified polymer may comprise a dynamic viscosity ranging from 20000 mPa∙s to 40000 mPa∙s. The use of the liquid polymer comprising these dynamic viscosities may allow for its use in automated and/or manual deposition processes.

In some embodiments, in the curing step(s), a curing temperature may range from 20°C to 150°C. In some embodiments, in the curing step(s), a curing temperature of may range from 30°C to 100°C. In some embodiments, in the curing step(s), a curing temperature ranging from 40°C to 50°C may be used.

In some embodiments, in the step of curing the liquified polymer, the curing time may range from 2 minutes to 750 minutes. In some embodiments, in the step of curing the liquified polymer, the curing time may range from 5 minutes to 390 minutes. In some embodiments, in the step of curing the liquified polymer, the curing time may range from 10 minutes to 180 minutes.

These curing conditions may allow for the cost- and energy-efficient process for the production of the sole structure.

In some embodiments, the outsole may be the sole structure according to some embodiments of the present disclosure. In addition, or alternatively, the sole structure may be a sole. Using the sole structure as an outsole and/or sole has shown to improve the traction of the shoe (e.g., the sports shoe).

Some embodiments of the present disclosure relate to a sole structure manufactured according to some embodiments of the method according to the present disclosure.

While the sole structure may be used to create a lighter and thinner, e.g., outsole, the sole structure may also be used to enhance the grip of the shoe (e.g., the sports shoe) for particular workouts, e.g., when arranging the liquified polymer in particular zones of the shoe (e.g., the sports shoe).

Some embodiments of the sole structure according to the present disclosure may enhance traction on smooth and wet surfaces while reducing the probability of slipping. When using the sole structure according to some embodiments of the present disclosure, the running performance of the wearer, e.g., an athlete may be improved. Due to the reduced risk of slipping, e.g., on wet and smooth surfaces, the sole structure may provide for an improved overall workout experience and result. For example, and when comparing to conventional sole structures, the sole structure according to some embodiments of the present disclosure may exhibit an improvement in friction. Moreover, the sole structure may have the advantage that it may be individually designed based on the friction force, which acts on the sole structure. Furthermore, the sole structure may be lighter and thinner, due to its materials and manufacturing method, making the overall sole structure more desirable.

Some embodiments of the present disclosure relate to an outsole manufactured according to some embodiments of the method according to the present disclosure. In some embodiments, the outsole may have a surface structure.

The outsole according to some embodiments of the present disclosure may be thinner and lighter than conventional sole structures. Moreover, in some embodiments, the outsole may be individually designed and adapted to specific needs of the user. In some embodiments, the outsole may comprise one or more surface structures. In some embodiments, the outsole comprises different surface structures, which may provide different functionalities to the outsole. In some embodiments, the outsole comprises a plurality of surface structures, which are identical in terms of pattern, but differ in depth, thickness or the like.

Some embodiments of the present disclosure relate to a sports shoe comprising a sole structure or an outsole according to some embodiments of the present disclosure.

The shoe (e.g., the sports shoe) comprising the outsole according to some embodiments of the present disclosure may be lighter, and thinner, making the overall sports shoe more desirable. In addition, in some embodiments, the shoe (e.g., the sports shoe) may exhibit the same and/or even enhanced durability and performance properties than conventional shoes or sports shoes.

The many advantages discussed in the context of some embodiments of the present disclosure may apply also to other embodiments of the present disclosure, i.e., the advantages discussed for some embodiments of the method according to the present disclosure may also apply to the sole structure, outsole, and sports shoe according to some embodiments of the present disclosure.

We emphasize that all aspects, features, and options discussed and disclosed above within the context of some embodiments may be applied to, or combined with, the discussion and disclosure of other embodiments, and vice versa, unless physically or technically ruled out, even if not every possible combination or sub-combination of features is explicitly spelled out in the following. The technical advantages of such options and features that have already been discussed above are therefore not repeated, at least not to the same degree of detail, and reference is instead made to the corresponding explanations above, for conciseness.

Several embodiments according to the present disclosure are described below, predominately with respect to shoes (e.g., sport shoes). It is, however, once again emphasized that the different embodiments may also be practiced in different kinds of soles and shoes and are not limited to the specific embodiments set forth below.

Reference is further made to the fact that in the following some embodiments may be described in more detail than other embodiments. A skilled artisan will understand that the features and possible modifications described with reference to these embodiments may also be further modified and/or combined with one another in a different manner or in different sub-combinations, without departing from the scope of the present disclosure. Individual features or sub-features may also be omitted if they are dispensable to obtain the desired result. In order to avoid redundancies, reference is therefore made to the explanations in the preceding discussion/sections, which also apply to the following description.

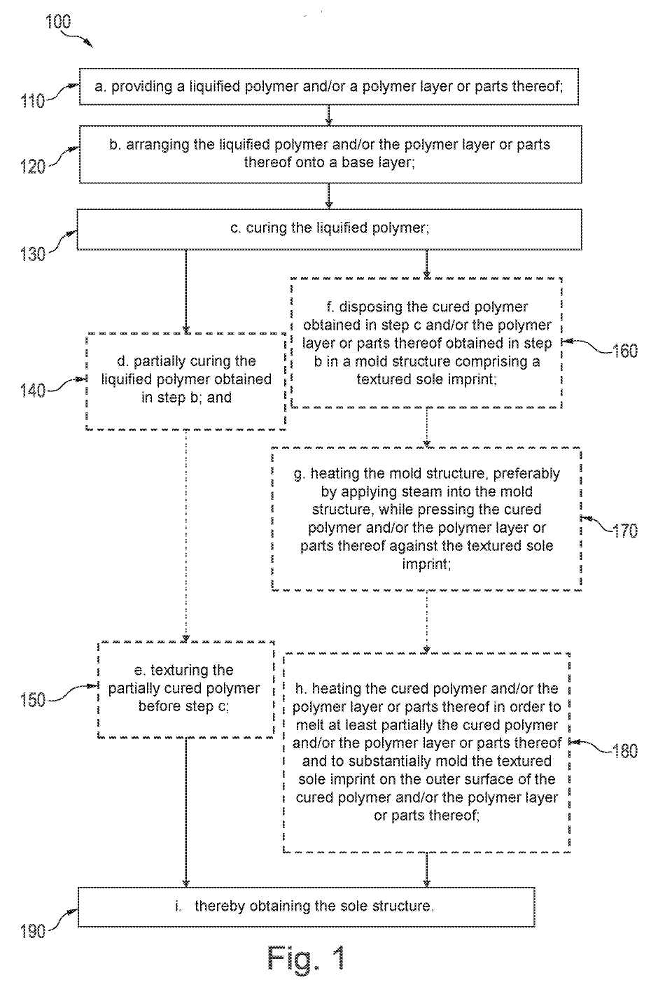

In FIG. 1, a flowchart for the method 100 for manufacturing a sole structure 240, such as sole structure 240 for a shoe 260 (e.g., a sports shoe) is shown.

In step 110, the liquified polymer may be provided. The liquified polymer may comprise a polymer and a solvent. In some embodiments, the ratio of the volume of the polymer to the volume of the solvent may range from 2:98 to 40:60, from 5:95 to 30:70, or from 10:90 to 20:80.

In some embodiments, the polymer may be characterized by a Shore A value and/or Shore D value, wherein the Shore A value may range from 20 to 120, from 40 to 100, or from 60 to 80; and the Shore D value may range from 2 to 80, from 5 to 75, or from 8 to 70. In some embodiments, the polymer may be selected from the group consisting of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

In some embodiments, the solvent may be a mixture selected from the group consisting of solvent-borne and/or water-borne solvents. In some embodiments, the solvent may be a mixture selected from the group of (C1-C6) ethers, (C1-C10) esters, (C1-C8) ketones, (C1-C8) alkanes, and/or combinations thereof. In some embodiments, the solvent may be a mixture of one or more of tetrahydrofuran (THF), methyl ethyl ketone (MEK), cyclohexane (CYC), ethyl acetate, and butyl acetate. In some embodiments, the ratio of this mixture may range from 10 volume % to 90 volume %, from 20 volume % to 80 volume %, or from 30 volume % to 70 volume %.

In some embodiments, the liquified polymer 230 may comprise a dynamic viscosity ranging from 10000 mPa∙s to 50000 mPa∙s, or from 20000 mPa∙s to 40000 mPa∙s. Furthermore, in some embodiments, in step 120 the liquified polymer may be arranged onto a base layer. The base layer may be a midsole, but can also be a layer, which is not part of the shoe (e.g., the sports shoe). In other words, in some embodiments, the base layer may be any layer for arranging the liquified polymer.

In step 110, in some embodiments, a polymer layer and parts thereof may be provided. In this regard, in some embodiments, the polymer layer and parts thereof may comprise cutouts. In some embodiments, these cutouts may comprise a pattern. For example, in some embodiments, the polymer layer may comprise cutouts in a square-shaped and/or rectangular pattern. Any pattern may be conceivable in this regard. In this context, the polymer layer or parts thereof may be arranged on a base layer. The base layer may be a midsole, but can also be a layer, which is not part of the shoe (e.g., the sports shoe). In other words, in some embodiments, the base layer may be any layer for arranging the liquified polymer.

In some embodiments, the liquified polymer 230 may be arranged onto the base layer with a thickness ranging from 1 mm to 10 mm. In some embodiments, the thickness ranges from 2 mm to 4 mm. In some embodiments, the thickness is 3 mm. In some embodiments, the base layer 250 may be a midsole and/or a shoe upper and/or parts thereof.

In some embodiments, the liquified polymer 230 may be arranged in a first section of the shoe 260 (e.g., the sports shoe) with a dynamic viscosity ranging from 30000 mPa∙s to 50000 mPa∙s and in a second section of the shoe 260 (e.g., the sports shoe) with a dynamic viscosity ranging from 10000 mPa∙s to 30000 mPa∙s. In some embodiments, the contact angle θ between the liquified polymer 230 and the base layer 250 may range from 30° to 110°, from 40° to 90°, or from 50° to 70°.

In some embodiments, when arranging the liquified polymer in step 120, at least one of the following techniques may be applied: brushing, coating, dipping, painting, automated dispensing, automated printing, and controlled dispensing.

In some embodiments, the liquified polymer may be arranged onto one or more sections of the shoe 260 (e.g., the sports shoe). In some embodiments, the sections may be a toe section, a forefoot section, a heel section, a midsole section, a sidewall section and/or an upper section. In some embodiments, the liquified polymer 230 may be also arranged onto one or more predetermined portions of the sports shoe 260 determined using a traction map, an abrasion map and/or a pressure map. In this manner, in some embodiments, the liquified polymer may be arranged based on individual needs and requirements of the wearer.

In step 120, in some embodiments, the polymer layer and parts thereof may be arranged on a carrier layer.

Method 100 as shown in FIG. 1 (as well as other embodiments of method 100) may comprise further the step of 130 of curing the arranged liquified polymer. In some embodiments, curing may be carried out using radiation. In some embodiments, the curing temperature may range from 20°C to 150°C. In some embodiments, the curing temperature may range from 30°C to 100°C, or from 40°C to 50°C. Furthermore, in some embodiments, the curing time may range from 2 minutes to 750 minutes, from 5 minutes to 390 minutes, or from 10 minutes to 180 minutes.

In some embodiments, the arranged liquified polymer obtained in step 120 (e.g., step b as described herein) may be partially cured in step 140 and textured 150 before step 130 (e.g., step c as described herein). In some embodiments, the curing time may range from 10 minutes to 60 minutes. In some embodiments, the curing time may range from 15 minutes to 40 minutes, or 20 minutes to 35 minutes. In some embodiments, the curing time may be 30 minutes.

In some embodiments, a texturing element may be applied on the partially cured polymer. The texturing element may be air-permeable. In this manner, the partially cured polymer may cure while being textured by the texturing element.

For example, in some embodiments, the texturing element may be applied onto the partially cured polymer for at least 5 minutes. In some embodiments, the application of the texturing element may be at least 1 hour, at least 6 hours, at least 12 hours, or at least 24 hours. In some embodiments, the texturing element may be a textile. However, in some embodiments, the texturing element may be also a stamp, an embossing element and/or a mold.

In some embodiments of the method according to the present disclosure, which may be performed in addition to other embodiments of the method described herein, the cured polymer of step 130 (e.g., step c as described herein) may be disposed in a mold structure 160. In some embodiments, the mold structure may comprise a textured sole imprint 340. Afterwards, in some embodiments, the mold structure may be heated in step 170. In some embodiments, this may be done by applying steam, e.g., done in a steam chest mold. Meanwhile in step 170, in some embodiments, the cured polymer may be pressed against the textured sole imprint of the mold structure. In some embodiments, in the subsequent step 180, the cured polymer may be heated in order to melt at least partially the cured polymer. In this manner, in some embodiments, the textured sole imprint may mold on the outer surface of the cured polymer.

In some embodiments, in the steps of 160 to 180, the base layer may be dried for 2 hours, 3 hours, or 4 hours. In some embodiments, drying may be performed by at least 50°C, at least 60°C, or at least 70°C. Drying may be performed by using heat.

In this regard, in some embodiments, steam chest molding may be preferred. In some embodiments, the temperature may be at least 130°C. In some embodiments, the temperature may be at least 150°C. In some embodiments, the temperature may be at least 160°C. In some embodiments, steaming may be performed in less than 30 seconds, in less than 45 seconds, or in less than 1 minute. In some embodiments, the steaming may be performed in at most 6 minutes, in at most 5 minutes, or in at most 3 minutes.

Some embodiments of the method according to the present disclosure may also apply to the polymer layer and/or parts thereof. For example, in some embodiments, the polymer layer and/or parts thereof may be disposed in a mold structure 160. The mold structure may comprise a textured sole imprint 340. Afterwards, in some embodiments, the mold structure may be heated in step 170. In some embodiments, this may be done by applying steam, e.g., done in a steam chest mold. Meanwhile in step 170, in some embodiments, the polymer layer and/or parts thereof may be pressed against the textured sole imprint of the mold structure. In some embodiments, in the subsequent step 180, the polymer layer and/or parts thereof may be heated in order to melt at least partially the cured polymer. In this manner, in some embodiments, the textured sole imprint may be molded on the outer surface of the cured polymer.

In some embodiments, in the steps of 160 to 180, the base layer may be dried for 2 hours, 3 hours, or 4 hours. In some embodiments, drying may be performed at least at 50°C, at least at 60°C, or at least at 70°C. Drying may be performed by using heat.

In some embodiments, the polymer layer and/or parts thereof may be textured in step 150 of method 100.

In some embodiments of method 100 shown in FIG. 1 (as well as other embodiments of method 100), the sole structure 240 may be obtained in step 190. In some embodiments, the thickness of the sole structure 240 may range from 0.3 mm to 0.7 mm. In some embodiments, the thickness of the sole structure 240 may be 0.5 mm. Furthermore, in some embodiments, the sole structure 240 may comprise a surface structure (e.g., pattern 400). In some embodiments, this surface structure may be selected from the group consisting of one or more of: a rectangle, a grid, a lattice, a line, a spiral, a honeycomb, dots, a wave or any combination thereof.

In some embodiments, the sole structure 240 may be an outsole 290 of the shoe 260 (e.g., the sports shoe). In some embodiments, an outsole 290 may be manufactured according to some embodiments of the method 100 shown in FIG. 1, which may have a surface structure (e.g., pattern 400). In some embodiments, a shoe 260 (e.g., a sports shoe) may comprise a sole structure or an outsole according some embodiments of the present disclosure.

In some embodiments, the textured cured polymer may have a length of at least 0.5 cm, at least 1 cm, at least 1.5 cm, or at least 2 cm and/or width of at least 0.7 cm, at least 1.5 cm, at least 2.3 cm, or at least 3 cm.

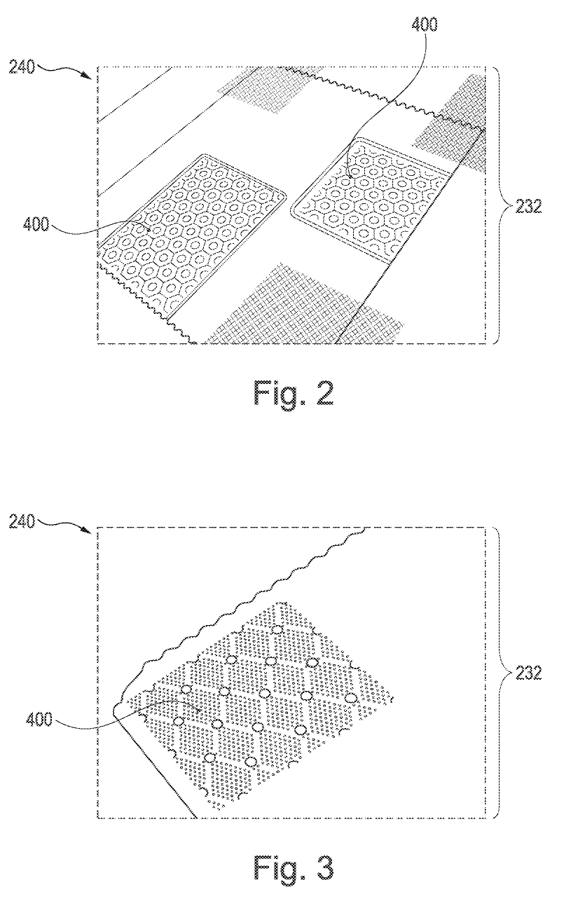

In order to avoid unnecessary redundancy, differences or additions to the embodiments of method 100 described in FIG. 1 will be discussed with respect to the embodiments shown in FIGS. 2 to 6.

FIG. 2 shows an embodiment of the sole structure 240 manufactured according to some embodiments of the method according to the present disclosure (described in the context of FIG. 1 above). In some embodiments, the sole structure 240 may have a rough texture and a matte design.

For example, in some embodiments, the sole structure 240 shown in FIG. 2 may be obtained by partially curing the liquified polymer after step d as described herein and texturing the partially cured polymer using a textile. In some embodiments, the partially cured polymer has been cured for 10 minutes to 60 minutes. In some embodiments, the partially cured polymer has been cured for 15 to 40 minutes, or for 20 to 30 minutes.

However, in some embodiments, the sole structure 240 shown in FIG. 2 may be obtained by disposing a polymer layer in a mold structure comprising a textured sole imprint, heating the mold structure by applying steam into the mold structure, while pressing the polymer layer against the textured sole imprint and heating the polymer layer in order to melt at least partially the polymer layer, and to substantially mold the textured sole imprint on the outer surface of the polymer layer.

In some embodiments, the pattern 400 may be obtained by texturing the partially cured polymer. For example, in some embodiments, a textile is permeable, e.g., a textile comprising a permeable lattice structure has been applied to the partially cured polymer. In some embodiments, permeable lattices for embossing may structures that allow the passage of air, heat, or material while simultaneously applying a pattern to a surface. For example, in some embodiments, perforated or mesh-like surfaces may be used that that allow air evacuation while pressing a pattern onto a material, e.g., made from rubber, silicone, polyester, or nylon.

As can be seen in FIG. 2, in some embodiments, the pattern 400 may be a honeycomb shaped-pattern. In some embodiments, the honeycomb-shaped pattern comprises a plurality of hexagonal shaped elements. In some embodiments, the pattern 400 may be a grid, a lattice, a line, a spiral, a honeycomb, dots, a wave, a sine wave pattern, or any combination thereof. The pattern 400 which is obtained in this manner, in some embodiments, may be shallow.

In some embodiments, force has been applied to the textile when applying to the partially cured polymer. In some embodiments, a force ranging from 5,000 kN to 15,000 kN has been applied during the step of texturing. In some embodiments, a force ranging from 1 N to 1,000 N has been applied during the step of texturing. In some embodiments, a force ranging from 10 N to 100 N has been applied during the step of texturing. In some embodiments, a force of approximately 50 N has been applied during the step of texturing. In this manner, in some embodiments, the force may promote the texture being applied to the partially cured polymer. For example, in some embodiments, the partially cured polymer may be soft and/or malleable during the step of texturing such that the force may be produce the desired texture.

In some embodiments, the texturing time may be at least 5 minutes, at least 1 hour, at least 6 hours, at least 12 hours, or at least 24 hours. Afterwards, in some embodiments, the textured polymer may be cured 232, thereby proving for the sole structure 240. In this manner, in some embodiments, the partially cured and textured polymer is cured completely.

FIG. 3 shows an embodiment of the sole structure 240 manufactured according to some methods according to the present disclosure (described in the context of FIG. 1 above). In some embodiments, the sole structure 240 may have a rough texture and a matte design.

In some embodiments, the pattern 400 may be obtained by partially curing the liquified polymer and texturing the partially cured polymer using a textile. In this manner, in some embodiments, the textile may provide for a pattern 400 which is shallow.

In some embodiments, the textile used for texturing the partially cured polymer may permeable, e.g., may comprises a permeable lattice structure. As can be seen in FIG. 3, in some embodiments, the pattern 400 may be a grid-like pattern. In some embodiments, the grid-like pattern may comprises two rectangular-shaped elements which are arranged in a repetitive manner. In some embodiments, the pattern 400 may be a grid, a lattice, a line, a spiral, a honeycomb, dots, a wave, a sine wave pattern, or any combination thereof.

In some embodiments, force has been applied to the textile when applying to the partially cured polymer during the step of texturing. In some embodiments, a force ranging from 5,000 kN to 15,000 kN may be applied during the step of texturing. In some embodiments, a force ranging from 1 N to 1,000 N has been applied during the step of texturing. In some embodiments, a force ranging from 10 N to 100 N has been applied during the step of texturing. In some embodiments, a force of approximately 50 N has been applied during the step of texturing. In this manner, in some embodiments, the force may promote the pattern being applied to the partially cured polymer. For example, in some embodiments, the partially cured polymer may be soft and/or malleable during the step of texturing such that the force may be produce the desired texture.

In some embodiments, the texturing time may be at least 5 minutes, at least 1 hour, at least 6 hours, at least 12 hours, or at least 24 hours. Afterwards, in some embodiments, the textured polymer may be cured 232, thereby proving for the sole structure 240. In this manner, in some embodiments, the partially cured and textured polymer may be cured completely.

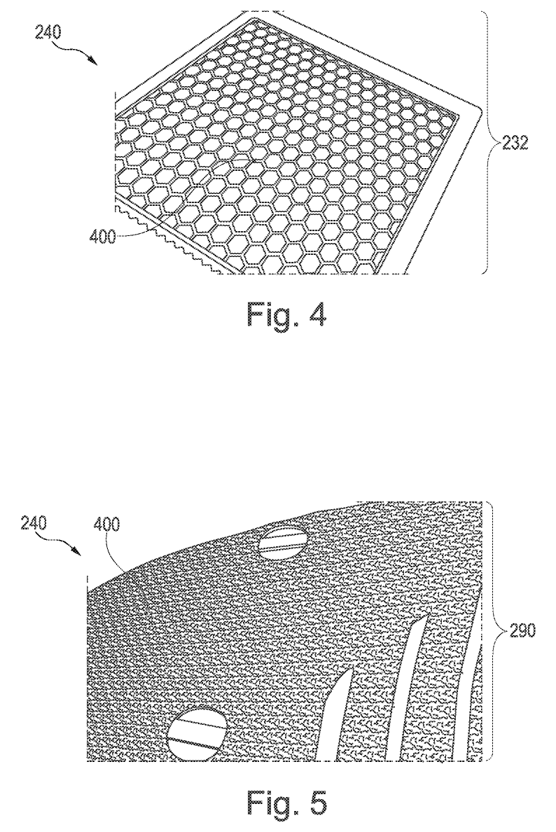

FIG. 4 shows an embodiment of the sole structure 204 manufactured according to some embodiments of the method according to the present disclosure (described in the context of FIG. 1 above). In some embodiments, the sole structure 240 may have a rough texture and a matte design.

In some embodiments, the pattern 400 may be obtained by partially curing the liquified polymer and texturing the partially cured polymer using a stamp. In this manner, in some embodiments, the textile may provide for a pattern 400 which is shallow.

As can be seen in FIG. 4, in some embodiments, the pattern 400 may be a honeycomb shaped pattern. In some embodiments, the honeycomb-shaped pattern may comprise a plurality of hexagonal shaped elements. In some embodiments, the pattern 400 may be a grid, a lattice, a line, a spiral, a honeycomb, dots, a wave, a sine wave pattern, or any combination thereof. In some embodiments, the pattern 400 which is obtained in this manner may be shallow.

In some embodiments, force has been applied to the stamp when applying to the partially cured polymer. In some embodiments, a force ranging from 5,000 kN to 15,000 kN has been applied during the step of texturing. In some embodiments, a force ranging from 1 N to 1,000 N has been applied during the step of texturing. In some embodiments, a force ranging from 10 N to 100 N has been applied during the step of texturing. In some embodiments, a force of approximately 50 N has been applied during the step of texturing. In this manner, in some embodiments, the force promotes the texture being applied to the partially cured polymer. For example, in some embodiments, the partially cured polymer may be soft and/or malleable during the step of texturing such that the force may be produce the desired texture. In some embodiments, the applied force may be less depending on the materials used.

In some embodiments, the stamp may be a roller or a plate with engraved or etched designs that are pressed into the sole structure material. In some embodiments, heat may be used during the process of texturing.

FIG. 5 shows an embodiment of an outsole 290 comprising the sole structure 240 according to some embodiments of the present disclosure. The sole structure 240 may be manufactured according to embodiments of the method according to the present disclosure. In some embodiments, the sole structure 240 may have a rough texture and a matte finish.

In some embodiments, the pattern 400 may be obtained by disposing the cured polymer in a mold structure with a sole imprint. In some embodiments, the mold structure may be heated by applying steam into the mold structure, while pressing the cured polymer indirectly against the sole imprint. Afterwards, in some embodiments, the cured polymer may be heated in order to melt at least partially the cured polymer and mold the sole imprint on the outer face of the cured polymer.

In some embodiments, the pattern 400 shown in FIG. 5 may be obtained by disposing a polymer layer in a mold structure comprising a textured sole imprint, heating the mold structure by applying steam into the mold structure, while pressing the polymer layer against the textured sole imprint and heating the polymer layer in order to melt at least partially the polymer layer, and to substantially mold the textured sole imprint on the outer surface of the polymer layer.

In some embodiments, the outsole 290 shown in FIG. 5 may be obtained in a similar manner, e.g., by using a heat press. For example, in some embodiments, the pattern 400 may be obtained by disposing the cured polymer in a mold structure with a sole imprint wherein the mold structure is heated while pressing the cured polymer against the sole imprint. As can be seen in FIG. 5, in some embodiments, the outsole 290 may have a pattern 400 which comprises a moss-like structure.

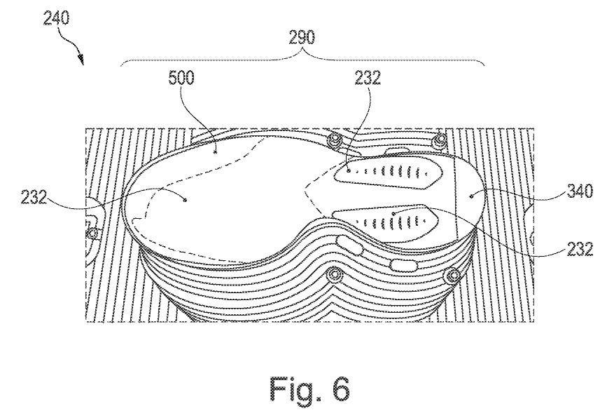

FIG. 6 illustrates the process of manufacturing the outsole of FIG. 5 according to some embodiments of the present disclosure. As can be seen in FIG. 6, in some embodiments, the outsole 290 may be made from the cured polymer 232. In some embodiments, a fiber material 500 may be layered in between the cured polymer and the sole imprint, e.g., an ultra-high-molecular-weight polyethylene (UHMWPE) fiber such as Dyneema. Other fiber materials may be used, such as (para-)aramid, polybenzoxazole, liquid crystal polymer, meta-aramid, or any combination thereof. In some embodiments, the cured polymer may be directly pressed against the sole imprint.

In some embodiments, the pattern 400 may be a grid, a lattice, a line, a spiral, a honeycomb, dots, a wave, a sine wave pattern, or any combination thereof. In some embodiments, the cured polymer 232 may be placed in between the fiber material 500 (shown as transparent sheet) and the mold structure comprising a sole imprint 340.

It is noted that the above embodiments and / or examples may be combined with other embodiments as described herein and details of the embodiments and / or examples may also be omitted, as will be understood by a skilled artisan. The scope of the present disclosure is not limited by the embodiments and / or examples disclosed in the above figures.

What is claimed is:

1. A method for manufacturing a sole structure, comprising:
providing a liquified polymer;
arranging the liquified polymer onto a base layer;
curing the liquified polymer;
disposing the cured polymer in a mold structure comprising a textured sole imprint;
heating the mold structure and pressing the cured polymer against the textured sole imprint;
heating the cured polymer to at least partially melt the cured polymer; and
molding the textured sole imprint on an outer surface of the at least partially melted cured polymer, thereby obtaining the sole structure.

2. The method according to claim 1, wherein the sole structure comprises a surface structure.

3. The method according to claim 2, wherein a shape of the surface structure is selected from the group consisting of: a rectangle, a grid, a lattice, a line, a spiral, a honeycomb, dots, or a wave.

4. The method according to claim 1, wherein the sole structure is an outsole of a shoe.

5. The method according to claim 1, wherein the liquified polymer is arranged onto one or more of a toe region, a forefoot region, a heel region, a midsole region, a sidewall region, or an upper region of a shoe.

6. The method according to claim 1, wherein the liquified polymer is arranged based at least in part on a traction map, an abrasion map, or a pressure map.

7. The method according to claim 1, wherein the liquified polymer is arranged onto the base layer with a thickness ranging from 1 mm to 10 mm.

8. The method according to claim 1, wherein a thickness of the sole structure ranges from 0.3 mm to 0.7 mm.

9. The method according to claim 1, wherein arranging the liquified polymer onto the base layer comprises brushing, coating, dipping, painting, automatically dispensing, automatically printing, or manually dispensing the liquified polymer onto the base layer.

10. The method according to claim 1, wherein the base layer is at least a portion of a midsole of a shoe or at least a portion of an upper of a shoe.

11. The method according to claim 1, wherein the liquified polymer is arranged in a first region of a shoe with a dynamic viscosity ranging from 30000 mPa∙s to 50000 mPa∙s, and wherein the liquified polymer is arranged in a second region of the shoe with a dynamic viscosity ranging from 10000 mPa∙s to 30000 mPa∙s.

12. The method according to claim 1, wherein a contact angle between the liquified polymer and the base layer ranges from 30° to 110°.

13. The method according to claim, wherein curing the liquified polymer comprises using radiation.

14. The method according to claim 1, wherein the liquified polymer comprises a polymer and a solvent, and wherein the polymer is selected from the group consisting of polyurethanes, thermoplastic polyamides, thermoplastic polyesters, thermoplastic styrenic block copolymers, thermoplastic polyurethanes, thermoplastic vulcanizates, and rubber or ethylene-vinyl copolymer.

15. The method according to claim 14, wherein the solvent is a mixture comprising a solvent-borne solvent and a water-borne solvent.

16. The method according to claim 14, wherein the solvent is a mixture comprising at least one of tetrahydrofuran, methyl ethyl ketone, cyclohexane, ethyl acetate, or butyl acetate.

17. The method according to claim 15, wherein the solvent-borne solvent is present in the mixture in an amount having a volume percent ranging from 10% to 90% relative to the total volume of the mixture, or wherein the water-borne solvent is present in the mixture in an amount having a volume percent ranging from 10% to 90% relative to the total volume of the mixture.

18. The method according to claim 1, wherein a Shore A value of the polymer ranges from 20 to 120, and wherein a Shore D value of the polymer ranges from 2 to 80.

19. The method according to claim 14, wherein a ratio of the volume of the polymer to the volume of the solvent ranges from 2:98 to 40:60.

20. The method according to claim 1, wherein the liquified polymer has a dynamic viscosity ranging from 10000 mPa∙s to 50000 mPa∙s.

21. The method according to claim 1, wherein curing the liquified polymer comprises curing the liquified polymer at a curing temperature ranging from 20°C to 150°C, and wherein curing the liquified polymer comprises curing the liquified polymer from 2 minutes to 750 minutes.
